(19) United States
(12) Patent Application Publication
(10) Pub. No.: US 2025/0171639 A1
(43) Pub. Date: May 29, 2025

(54) UV-CURABLE AQUEOUS PRECURSOR FOR DEPOSITION OF LOW REFRACTIVE INDEX POROUS FILMS

(71) Applicant: Phosio Corporation, Corvallis, OR (US)

(72) Inventors: Omid Sadeghi, Corvallis, OR (US); Cory K. Perkins, Salem, OR (US)

(21) Appl. No.: 18/961,275

(22) Filed: Nov. 26, 2024

Related U.S. Application Data
(60) Provisional application No. 63/603,041, filed on Nov. 27, 2023.

(51) Int. Cl. C09D 1/00; C08K 3/20; C08K 3/24; C09D 5/00

(52) U.S. Cl. CPC C09D 1/00; C09D 5/006; C08K 3/20; C08K 3/24

(57) ABSTRACT

A porogenic aqueous precursor is used to make a porous metal-oxide film via liquid-phase deposition. The porogenic aqueous precursor comprises one or more metal-ion species, one or more photosensitive agents each configured to interact with at least one of the metal-ion species, and one or more porogen species.

### CROSS REFERENCE TO RELATED APPLICATION

This disclosure claims priority to U.S. Provisional Patent Application Ser. No. 63/603,041, filed 27 Nov. 2023, the entirety of which is hereby incorporated herein by reference, for all purposes.

### TECHNICAL FIELD

This disclosure relates generally to materials engineering and more particularly to the fabrication of porous, metal-oxide films.

### BACKGROUND

Transparent films of low refractive index n can be useful for such applications as anti-reflective coatings. A desirable anti-reflective coating for an optical substrate would have a graded refractive index, approaching n=1.0 at the air-film interface and gradually increasing to the same refractive index as the substrate (e.g., glass at n=1.5). However, reliable engineering of a controlled refractive-index gradient within a thin film, on the depth scale of tens or hundreds of nanometers, is heretofore challenging.

Porous thin films are attractive candidate materials toward this goal, as they incorporate air (n=1) in the pores, which lowers the overall refractive index commensurate to the volume fraction of the air in the films. Nevertheless, thin films of high quality are typically fabricated via high-vacuum processing, the nature of which makes it difficult to produce significantly porous films. Sol-gel processing has been explored vigorously in recent years as a liquid-phase alternative for making porous metal-oxide films. The sol-gel environment is not ideal for this application, however, as it typically promotes nanoparticle formation, which may result in rough, discontinuous films.

### SUMMARY

One aspect of this disclosure relates to a method for making a porous metal-oxide film via liquid-phase deposition. The method comprises: (a) coating a substrate with a porogenic aqueous precursor comprising one or more metal-ion species, one or more photosensitive agents each selected to interact with at least one of the metal-ion species, and one or more porogen species; and (b) exposing the substrate as coated to one or more of ultraviolet light or elevated temperature under an oxidizing atmosphere, thereby decomposing the one or more photosensitive agents and porogen species and forming a porous network of oxide-bridged metal ions.

Another aspect of this disclosure relates to a porogenic aqueous precursor for making a porous metal-oxide film via liquid-phase deposition. The porogenic aqueous precursor comprises one or more metal-ion species, one or more photosensitive agents each configured to interact with at least one of the metal-ion species, and one or more porogen species.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

FIG. 1 shows aspects of an example method for making porous metal-oxide films via liquid-phase deposition.

FIG. 2 shows aspects of an example multi-lamellar film structure.

FIG. 3 shows example mass-spectrometry data illustrating thermal desorption and pyrolysis from a coated substrate at different stages of formation of a porous film of aluminum oxide made according to the method of FIG. 1.

FIG. 4 is a plot versus wavelength of the refractive index of the film of FIG. 3 after the annealing stage.

FIG. 5 is a plot versus wavelength of the refractive index and extinction coefficient of another porous film of aluminum oxide made according to the method of FIG. 1.

FIG. 6 is a plot versus wavelength of the refractive index and extinction coefficient of an example porous film of titanium oxide made according to the method of FIG. 1.

FIG. 7 is a plot versus wavelength of the refractive index and extinction coefficient of an example porous film of zirconium dioxide made according to the method of FIG. 1.

FIG. 8 is a plot versus wavelength of the refractive index and extinction coefficient of an example porous film of bismuth-doped aluminum oxide made according to the method of FIG. 1.

### DETAILED DESCRIPTION

Disclosed herein are methods and synthetic precursors for making porous metal-oxide films via liquid-phase processing and curing by exposure to ultraviolet (UV) light or elevated temperature under an oxidizing atmosphere. A wide variety of porous metal-oxide films can be formed in this manner-films of aluminum oxide (Al₂O₃), titanium dioxide (TiO₂), and/or zirconium dioxide (ZrO₂), for instance. Such films have rationally controllable porosity, can be patterned, and are suitable for various optical and holographic applications.

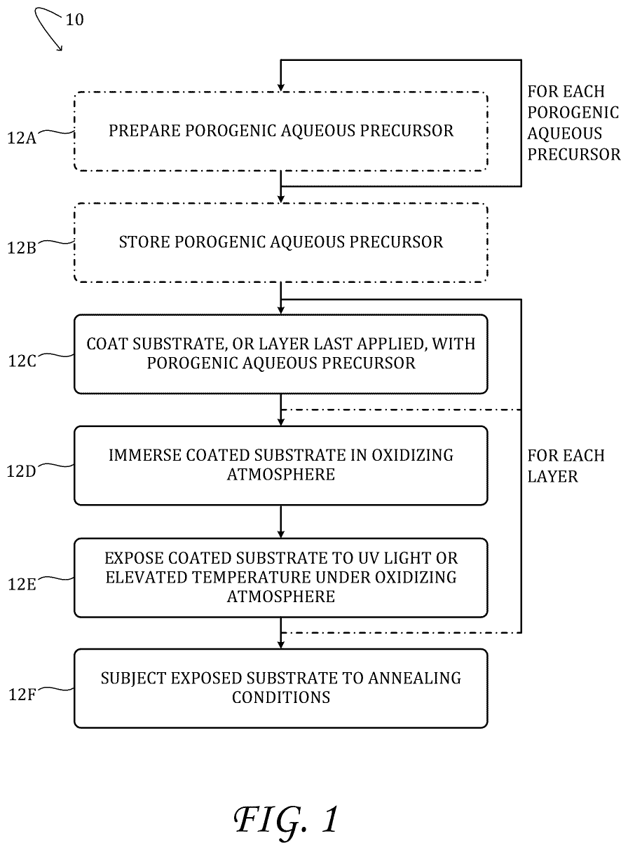

FIG. 1 shows aspects of an example method 10 for making a porous metal-oxide film via liquid-phase deposition. Method 10 may be used to make a bi-lamellar structure comprising a single film layer formed on a substrate, or, a multi-lamellar structure comprising a stack of film layers arranged on a substrate.

At 12A of method 10, one or more porogenic aqueous precursors is prepared. Each porogenic aqueous precursor is an aqueous solution or colloidal suspension comprising one or more metal-ion species, one or more photosensitive agents, each selected to interact with at least one of the metal-ion species, and one or more porogen species.

A metal-ion species included in a porogenic aqueous precursor may be selected from a wide variety of metal ions. In films made according to method 10, each metal ion has a relatively high oxidation state and is bridged by oxide (O²⁻) anions. Each film admits of an electronic band structure, accordingly, and has an optical absorption spectrum determined largely by its bandgap. To a reasonable approximation, the bandgap varies according to the energy of the lowest-lying, unoccupied electronic states of the metal ions in the film. Accordingly, for films intended to be used for optical applications in the visible, metal-ion species can be chosen in view of their energy states, such that the resulting film will be transparent in the visible. For films intended to be used for optical applications extending into the infrared (IR), the metal-ion species can be chosen such that the resulting film will be transparent in the near IR. For films intended to be used for optical applications extending into the UV, the metal-ion species can be chosen such that the resulting film will be transparent in the near UV.

In some examples the oxidation state of the metal-ion species included in a porogenic aqueous precursor may differ from the oxidation state of the corresponding metal ion in the corresponding film; in other examples the oxidation states may be the same. Metal-ion species of various oxidation states may be included in a porogenic aqueous precursor. Example trivalent metal-ion species include aluminum (Al³⁺), scandium (Sc³⁺), titanium (Ti³⁺), gallium (Ga³⁺), yttrium (Y³⁺), zirconium (Zr³⁺), niobium (Nb³⁺), indium (In³⁺), antimony (Sb³⁺), tellurium (Te³⁺), bismuth (Bi³⁺), lanthanum (La³⁺), hafnium (Hf³⁺), as well as the lanthanides cerium (Ce³⁺), praseodymium (Pr³⁺), neodymium (Nd³⁺), europium (Eu³⁺), and terbium (Tb³⁺). Example divalent metal-ion species include tin (Sn²⁺), zinc (Zn²⁺), and strontium (Sr²⁺). Example monovalent metal-ion species include lithium (Li⁺). Other metal-ion species may be included as well.

The counterion associated with a metal-ion species in a porogenic aqueous precursor is not strictly limited. Nevertheless, a counterion which, upon photolysis or pyrolysis under an oxidizing atmosphere (vide infra), leaves behind no non-volatile residue other than oxide (O²⁻) may be preferred. Examples include nitrate (NO₃⁻) and nitrite (NO₂⁻). In examples in which a porogenic aqueous precursor comprises an acidic agent, counterions hydroxide (OH⁻), carbonate (CO₃²⁻), and bicarbonate (HCO₃⁻) may be preferred.

In some examples, mixtures of two or more metal-ion species may be used in the same porogenic aqueous precursor. That approach may help to secure an amorphous metal-oxide phase in the corresponding film, as the concurrent presence of two or more metal-ion species during crystallization limits the crystalline-domain size of any given species. The resulting films may be denoted Al/Ti/O, Ti/Nb/O, Zr/Ti/O, Ce/Ti/O, La/Ti/O, Li/La/Ti/O, Nb/La/Li/Ti/O, Al/Nb/La/Li/Ti/O, Hf/O, Li/Ti/O, Sr/Ti/O, Y/Ti/O, Nb/Ti/O, Sn/Ti/O, Bi/Ti/O, La/Al/O, Sr/Al/O, Y/Al/O, Nb/Al/O, Sn/Al/O, Bi/Al/O, and La/Al/O, as examples, with no reference to stoichiometry and where O stands for oxygen.

The photosensitive agents selected to interact with a metal-ion species of a porogenic aqueous precursor will now be described. It was noted above that the desired films may comprise metal ions in relatively high oxidation states (e.g., Ti⁴⁺). Some metal ions in relatively high oxidation states are liable, however, to form oxide-bridged precipitates in aqueous solution. This property may significantly limit the shelf life of a porogenic aqueous precursor—i.e., the time available between preparation and application of the precursor. It may be desirable, therefore, for a porogenic aqueous precursor to supply each metal-ion species in a relatively low oxidation state, even if the oxidation state of the corresponding metal ion in the resulting film is greater.

Accordingly, a porogenic aqueous precursor may comprise one or more photosensitive agents that stabilize an included metal-ion species in a relatively low oxidation state. Some example photosensitive agents include selected Brønsted-Lowry (BL) acids (sources of H₃O⁺ in aqueous solution). Generally speaking, the lower pH values brought about by including BL acids increase the reduction potentials of the metal-ion couples (e.g., Ti⁴⁺/Ti³⁺), thereby stabilizing the lower oxidation state. BL acids may also have additional stabilizing effects toward other constituents of a porogenic aqueous precursor.

Seating metal ions in stable coordination environments is another way to discourage formation of oxide-bridged precipitates in aqueous solution. Accordingly, example photosensitive agents of a porogenic aqueous precursor may include ligands with significant affinity for the included metal-ion species. Such ligands comprise Lewis bases, generally. Conveniently, in examples in which a porogenic aqueous precursor includes a BL acid HX, the conjugate base X⁻ of that acid will be a Lewis base and may be a suitable, stabilizing ligand for the included metal-ion species. Thus, at least one of the photosensitive agents included in a porogenic aqueous precursor may be an agent that ionizes in aqueous solution, thereby providing a ligand for at least one of the included metal-ion species. Ligands particularly effective in this role are chelating ligands, such as carboxylates.

Additional photosensitive ligand agents that can be included in a porogenic aqueous precursor are ligands derived from hydrogen peroxide (H₂O₂). Such ligands include peroxide (O₂²⁻) and hydroperoxide (HO₂⁻) anions, which can function as chelating or bridging ligands. These ligands, as well as the H₂O₂ parent, are metastable: disproportionation of peroxides into diatomic oxygen (O₂) and water (or hydroxide or oxide, depending on the pH) is spontaneous, but can be very slow under ambient conditions, and slower still when the peroxide is coordinated to a metal ion. Moreover, coordinated and non-coordinated peroxides may function both as reductants and as oxidants. As a reductant, a peroxide may stabilize the lower oxidation state of a metal-ion species in a porogenic aqueous precursor. As an oxidant, a peroxide may take part in promoting a metal-ion species in a relatively low oxidation state to a desired, higher oxidation state under film-forming conditions.

Another important feature of a photosensitive agent selected to interact with a metal-ion species is that the photosensitive agent should leave behind little or no non-volatile residue after the film has been formed. Accordingly, a photosensitive agent should photolyze, volatilize, and/or pyrolyze completely under film-forming conditions, leaving behind no solid residue other than O²⁻.

In view of these and the foregoing considerations, two photosensitive agents that have proved useful in the porogenic aqueous precursors studied thusfar are formic acid (HCOOH) and hydrogen peroxide. In some examples, both photosensitive agents may be included together in the same porogenic aqueous precursor. Each of HCOOH, HCOO⁻, H₂O₂, HO₂⁻, and O₂²⁻ has a HOMO-LUMO gap low enough to be excited by UV light. When so excited, formic acid and formate rapidly photolyze and ultimately form hydrogen and carbon dioxide, which are volatile. Likewise, the peroxides photolyze to form O₂ and water (or hydroxide or oxide, depending on the pH). The oxidizing atmosphere under which the UV exposure is conducted (vide infra) may also assist in the decomposition and volatilization of the photosensitive agents. Accordingly, the one or more photosensitive agents included in a porogenic aqueous precursor may be configured to photolyze, volatilize, and/or pyrolyze upon exposure to ultraviolet light or elevated temperature under an oxidizing atmosphere, leaving behind no solid residue other than O²⁻.

In some examples the concentration range of a photosensitive agent in a porogenic aqueous precursor can be from 0.01 to 0.9 molar percent.

The one or more porogen species of a porogenic aqueous precursor will now be described. In some examples a suitable porogen comprises a surfactant capable of forming, in aqueous solution, a colloidal suspension, such as a micellar suspension. In some examples, the suspended micelles are about 0.5 to 50 nanometers (nm) in diameter. Without tying this disclosure to any particular theory, it is believed that porogen micelles suspended in the porogenic aqueous precursor substantially exclude the metal-ion species from the volumes they occupy. Accordingly, the metal-oxide network formed subsequently in method 10 is constrained to form around the void space of each micelle, resulting in a porous structure. In some examples the concentration range of a porogen in a porogenic aqueous precursor can be from about 0.1 to about 1 molar percent. In some examples the concentration range of a porogen in a porogenic aqueous precursor can be from about 0.1 to about 10 molar percent. In some examples the concentration range of a porogen in a porogenic aqueous precursor can be from about 0.1 to about 30 molar percent, or greater.

Like the photosensitive agents discussed above, the one or more porogen species are configured to photolyze, volatilize, and/or pyrolyze upon exposure to UV light or elevated temperature under an oxidizing atmosphere, leaving behind no solid residue other than O²⁻.

In some examples a porogen may comprise a non-ionic surfactant. Some non-ionic surfactants have a hydrophobic tail appended to a hydrophilic chain, such as an ethylene-oxide, propylene-oxide, or other oxide block. Example non-ionic surfactants include the Pluronic copolymers series (e.g., P123, F127, 31R1, etc., products of BASF of Ludwigshafen, Germany) and the Triton X series (of Dow Chemical of Midland, Michigan). Pluronic F127 is generically known as poloxamer 407; it is a tri-block copolymer consisting of a central hydrophobic block of polypropylene glycol flanked by two hydrophilic blocks of polyethylene glycol (PEG). The approximate length of the two PEG blocks is 101 repeat units, while the approximate length of the propylene glycol block is 56 repeat units. Other examples include the Tween series of polysorbate surfactants (of Uniqema Americans LLC of New Castle, Delaware), the Brij series (of Thermo Fisher Scientific of Waltham, Massachusetts), and various polyethylene-glycol surfactants.

In some examples a porogen may comprise an ionic surfactant. Some ionic surfactants have a hydrophobic (e.g., hydrocarbon) tail appended to a hydrophilic head group, and an associated counterion. Suitable ionic surfactants can be cationic, anionic, or zwitterionic. Zwitterionic surfactants may include cationic and anionic groups arranged in the same molecule, oligomer, or macromolecule.

For cationic surfactants, the hydrophilic head group may comprise ammonium with one more organic substituents. Example cationic surfactants include cetyltrimethylammonium bromide (CTAB), cetyltrimethylammonium chloride (CTAC), dodecyltrimethylammonium bromide (DTAB), dodecyltrimethylammonium chloride (DTAC). For anionic surfactants, the hydrophilic head group may comprise carboxylate, sulfonate, organosulfate, phosphonate, or organophosphate. Example anionic surfactants include sodium dodecyl sulfate (SDS). Example zwitterionic surfactants include carboxybetaine surfactants, phosphobetaine surfactants, sulfobetaine surfactants, and betaine surfactants.

Continuing in FIG. 1, in some examples step 12A is repeated for each and every porogenic aqueous precursor used for forming a multi-lamellar film structure. In other examples step 12 is enacted only once.

At 12B the one or more porogenic aqueous precursors are stored. In some examples and scenarios a porogenic aqueous precursor may be stored at room temperature, in the dark. In some examples and scenarios a porogenic aqueous precursor may be stored under refrigeration, in order to retard degradation of the photosensitive agents and precipitation of the metal-ion species. In some examples and scenarios a porogenic aqueous precursor may be stored for days, weeks, or months.

In method 10 one or more film layers are formed on a substrate. The configuration and composition of the substrate are not particularly limited. For optical applications the substrate may comprise glass or quartz. In some examples the substrate may comprise an optical flat.

At 12C a substrate, or the layer of a coated substrate last applied, is coated with a porogenic aqueous precursor—e.g., one of the porogenic aqueous precursors described above. A porogenic aqueous precursor can be applied to a substrate using any of a number of liquid-phase deposition methods. Such methods include spin-on deposition, dip-coating deposition, doctor-blade deposition, spray coating, roller coating, slot-die coating, and printing, as examples.

At 12D the coated substrate is immersed in an oxidizing atmosphere. In some examples the oxidizing atmosphere may comprise ozone (O₃). In some examples the oxidizing atmosphere may comprise nitrous oxide (N₂O). In some examples, either of these gases may be diluted with O₂ or air to a desired partial pressure. In some examples the oxidizing atmosphere may comprise only O₂ or only air. In some examples the oxidizing atmosphere may be maintained at a temperature that differs from ambient temperature—i.e., above or below ambient temperature. In some examples the oxidizing atmosphere may be maintained at a pressure that differs from atmospheric pressure—i.e., above or below atmospheric pressure. In order to facilitate subsequent UV exposure, the oxidizing atmosphere and coated substrate may be contained within chamber having a UV-transparent window, such as a window made of quartz.

At 12E the coated substrate is exposed to UV light or elevated temperature under the oxidizing atmosphere. In some examples the coated substrate is exposed to about 5 to 10,000 milliwatts per square centimeter of UV light. In some examples the UV light may fall within the wavelength range of 10 to 400 nm. Exposure to UV light or elevated temperature under the oxidizing atmosphere decomposes the one or more photosensitive agents and the one or more porogen species of the porogenic aqueous precursor and forms a porous network of oxide-bridged metal ions. The heat evolved from the UV exposure volatilizes the residues of the photosensitive agents, porogen species, and counterions, as well as the water included in the porogenic aqueous precursor. In other words, the photosensitive agents, porogen species, and counterions photolyze, volatilize, and/or pyrolyze upon exposure to the ultraviolet light or elevated temperature under the oxidizing atmosphere, leaving behind no solid residue other than O²⁻. This ‘curing’ action creates the desired metal-oxide film structure, which is both porous and amorphous.

In some examples, after exposure to the UV light or elevated temperature under the oxidizing atmosphere, method 10 returns to 12C, where an additional coating of a porogenic aqueous precursor is applied to the coated substrate. In some examples the additional coating can be the same as the coating last applied (in order to achieve greater film thickness). In some examples, however, the additional coating may comprise a different porogenic aqueous precursor. A multi-lamellar structure of arbitrary dimensions, layer thickness, physicochemical composition, and/or porosity can be built up in this manner. In other examples a multi-lamellar structure may be built up by successive application of porogenic aqueous precursors which are not immersed in the oxidizing atmosphere and exposed to the UV light or elevated temperature before the next coating is applied.

At 12F the exposed substrate subjected to annealing conditions. In some examples the exposed substrate is annealed in air. In some examples the annealing temperature is between 25° and 350° C. In some examples the annealing time is between 5 minutes and 4 four hours. Generally speaking, the annealing reduces mechanical stress in each cured film, at the interface between the substrate and the film first applied to the substrate, and at each interface between films (if any).

As a porous metal-oxide film incorporates air in its pores, the refractive index of a porous metal-oxide film is lower than that of a non-porous film of the same material composition. Accordingly, each annealed film may have a desirably low refractive index n, where 1<n<1.55. Method 10 may be used to make films with refractive indices in this range, in bi-lamellar (one film layer on a substrate) and in multi-lamellar structures.

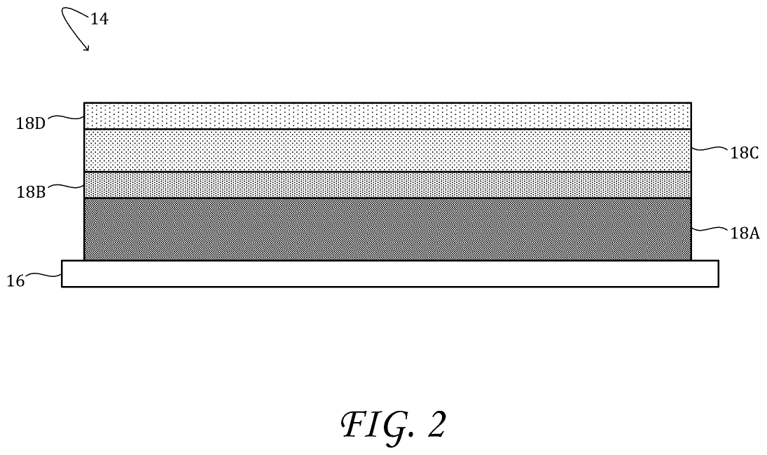

FIG. 2 shows aspects of an example multi-lamellar film structure 14. Structure 14 includes a substrate 16 and a stack of porous metal-oxide film layers 18 arranged on the substrate. In some examples, one or more film layers of a multi-lamellar film structure may have a different thickness than one or more other layers. In some examples, one or more film layers of a multi-lamellar film structure may have a different refractive index than one or more other layers. The refractive indices may differ due to differing metal-oxide composition, differing porosity (indicated by the dot density in the drawing), or both. FIG. 2 shows film layers 18A, 18B, 18C, and 18D, which vary in thickness and in porosity. Other multi-lamellar film structures may include additional film layers or fewer film layers, distinct film layers of the same thickness, a stack of film layers alternating between a higher porosity and a lower porosity, and so forth. In some examples, any, some, or all of the stacked film layers may have a refractive index from 1 to less than 1.55.

In some examples a multi-lamellar film structure may support a discrete refractive-index gradient which varies from one film layer to the next, from a first refractive index of one film layer to a second refractive index of another film layer. In these and other examples, the different layers of the multi-lamellar film structure can be made using porogenic aqueous precursors of different porogen concentrations, thereby providing different refractive indices for the different layers. In other words, the refractive index of a metal-oxide film can be tuned by varying a concentration of surfactant in a aqueous precursor, for instance. This feature is demonstrated hereinafter.

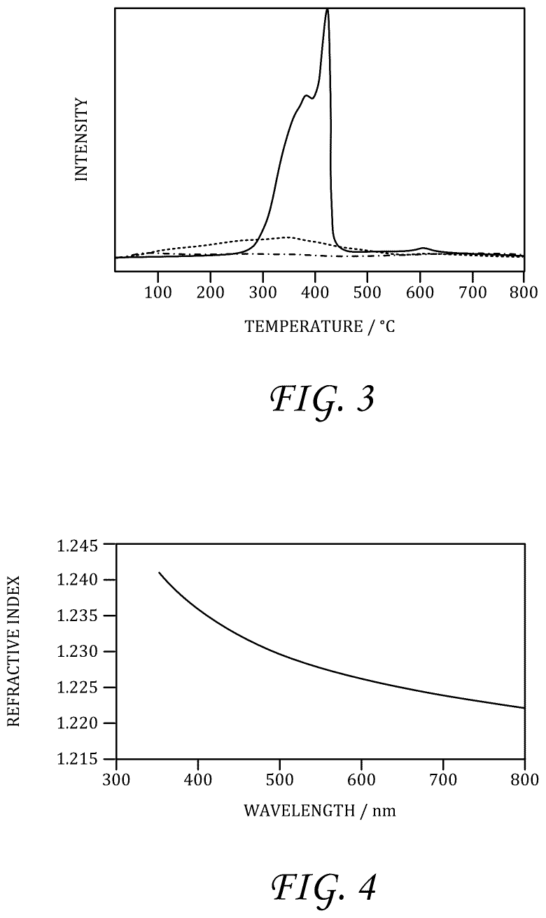

FIG. 3 shows example mass-spectrometry data illustrating thermal desorption and pyrolysis from a coated substrate at different stages of formation of a porous film of aluminum oxide (Al₂O₃) made according to the method of FIG. 1. The solid line shows the data for the film in the uncured state. The dashed line shows the data for the film after one hour of UV exposure. The dot-dashed line shows the data for the film after two hours of UV exposure. In these experiments, the UV light at 365 nm was used. The porous Al₂O₃ film was made as follows. A porogenic aqueous precursor was prepared by dissolving 1 molar equivalent of Al(OH)₃ in 2 molar equivalents HCOOH in water. The non-ionic block copolymer, Pluronic F127 was added to 10% weight-to-volume (wt/v) of the porogenic aqueous precursor. Solutions were spin coated at 3000 revolutions per minute (rpm) for 30 seconds(s) onto a glass substrate prior to UV exposure. As shown in FIG. 3, the unexposed film evolved carbon dioxide at temperatures of about 300 to 450° C. The film that was exposed to UV for one hour evolved much less carbon dioxide, and the film that was exposed for two hours evolved essentially no carbon dioxide. This indicates that UV exposure decomposed the surfactant.

FIG. 4 is a plot versus wavelength of the refractive index of a film made using the same porogenic aqueous precursor as described for FIG. 3, but subjected to a 15 min UV cure, followed by annealing at 250° C. for 10 min. The refractive index of the above Al₂O₃ film was 1.225 at 550 nm. In contrast, a non-porous Al₂O₃ film treated under the same conditions, but omitting the porogen from the porogenic aqueous precursor, had an index of refraction of 1.51 at 550 nm. This is evidence that addition of the porogen made pores in the film. It was observed also that the refractive index of the film can be varied based on the amount of porogen incorporated into the porogenic aqueous precursor (vide infra).

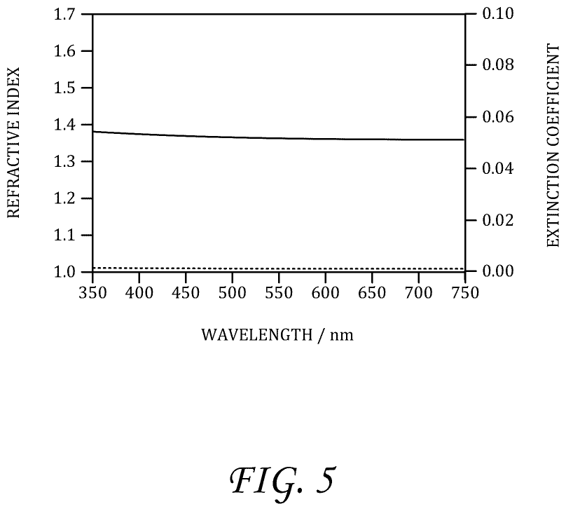

FIG. 5 is a plot versus wavelength of the refractive index (solid line) and extinction coefficient (dashed line) of another porous film of aluminum oxide made according to the method of FIG. 1. FIG. 5 illustrates the effect of the porogen concentration of a porogenic aqueous precursor on the refractive index of the corresponding film. Here the same conditions were used as for the film of FIG. 4, except that the porogen concentration was reduced to 5% wt/v. The refractive index at 550 nm increased to 1.363, which is greater than the film of FIG. 4, but less than the comparative film in which no porogen was used. This result demonstrates that the refractive index can be controlled by variation of the porogen concentration.

The porogenic aqueous precursor used in making the films of FIGS. 4 and 5 is amenable also to different curing modes, which lead to Al₂O₃ films of different densities and refractive indices. For example, when all other conditions remain the same as described for FIG. 5, but the UV exposure time is reduced from 15 min to 5 min, the refractive index of the resulting film increases from 1.363 to 1.446. However, when the UV exposure is preceded by a 2.0 min pre-bake at 50° C. and also followed by a 5-min immersion in absolute ethanol, the refractive index of the resulting film is now 1.371. In other words, the pre-bake, UV-exposure, ethanol immersion cure restores most of the porosity that was lost due to the shorter UV-exposure. The use of ethanol as the immersion solvent should not be construed as limiting in any sense, because other water-miscible solvents may be used instead-methanol, acetone, 2-propanol, etc.

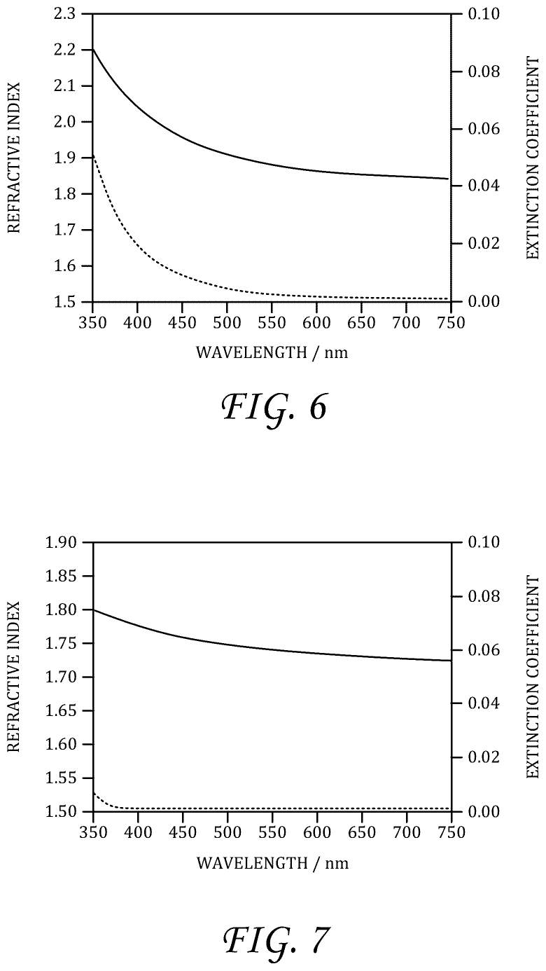

FIG. 6 is a plot versus wavelength of the refractive index (solid line) and extinction coefficient (dashed line) of an example porous film of TiO₂ made according to the method of FIG. 1. In FIG. 6, the porogenic aqueous precursor was prepared by adding about 0.5 mL HCOOH to 4 mL titanium trichloride (TiCl₃) in hydrochloricacid (3% by mass). Pluronic F127 was added to 10% wt/v. The porogenic aqueous precursor was spin coated onto a glass substrate at 3000 rpm for 30 s. After spin coating, the film was placed in a UV/O₃ chamber and exposed to UV light or elevated temperature as described above. After the exposure, the film was annealed at 300° C. As shown in FIG. 6, the refractive index of the porous film was about 1.52 at 550 nm. In contrast, the refractive index of a non-porous film prepared in exactly the same way, but omitting the porogen, was about 2.15 at 550 nm.

FIG. 7 is a plot versus wavelength of the refractive index (solid line) and extinction coefficient (dashed line) of an example porous film of zirconium dioxide made according to the method of FIG. 1. In FIG. 7, the porogenic aqueous precursor was prepared by mixing about 1 gram zirconium oxychloride (ZrOCl), 1 mL HCl (aq) 12 molar solution, 1 mL of 30% aqueous H₂O₂, and 1 mL HCOOH (10 molar aqueous solution). Pluronic F127 was added to 10% wt/v. The porogenic aqueous precursor was spin coated onto a glass substrate at 3000 rpm for 30 s. After the exposure, the film was annealed at 300° C. As shown in FIG. 7, the refractive index of the porous film was about 1.75 at 550 nm. In contrast, the refractive index of a non-porous film prepared in exactly the same way, but omitting the porogen, was about 2.05 at 550 nm.

Although narrower bandgaps reduce the wavelength range in which a metal-oxide film is transparent, some metal-ion species with low-lying electronic states may be added to a porogenic aqueous precursor in order to secure a manufacturing advantage. In particular, incorporation of Bi³⁺ or other ions with low-lying electronic states tends to impart increased UV sensitivity to the porogenic aqueous precursor, which significantly reduces the required UV exposure time at constant UV intensity.

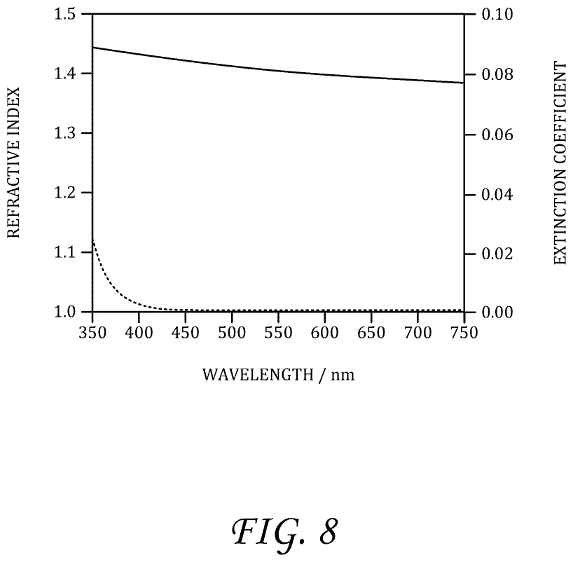

For example, FIG. 8 shows a plot versus wavelength of the refractive index (solid line) and extinction coefficient (dashed line) of an example porous film of bismuth-doped aluminum oxide made according to the method of FIG. 1. The time require to cure this coating was about ten minutes, as opposed to thirty minutes for the example of FIGS. 3 and 4, where no Bi³⁺ was used. By inference, the increased UV absorption provides additional heating, which decreases the cure time.

Naturally, various elements besides Bi may be used for doping Al₂O₃, ZrO₂, and other metal-oxide films. Suitable dopant elements include Ce, Sn, Sb, Zn, Ga, In, Ti, La, Eu, Pr, Tb, Nd, or Te, for example. The concentration range of the dopant metal ion can be 0.1 to 30 molar percent, or greater, based upon the total metal ion concentration in the porogenic aqueous precursor.

No aspect of the foregoing drawings or description should be interpreted in a limiting sense, because numerous variations, extensions, and omissions are also envisaged. For instance, method 10 of FIG. 1 includes both the preparation of porogenic aqueous precursors as well as the use of the porogenic aqueous precursors for making metal-oxide films and film structures. These features can be enacted sequentially, as indicated, but can also be enacted separately—e.g., by different actors. In other words, the precursor-preparation steps are optional in methods for making a film, just as the deposition, UV curing, and annealing steps are optional in methods for preparing a porogenic aqueous precursor.

Further, in variants in which method 10 is used to make a multi-lamellar film structure, it may or may not be the case that each and every layer is formed by application of a porogenic aqueous precursor to the last layer applied, followed by UV curing and annealing. In some examples, one or more layers can be added, via a different method, to a multi-lamellar structure made according to method 10. Further still, a multi-lamellar structure made by any method may be used as the ‘substrate’ in method 10.

This disclosure identifies ‘exposure to one or more of UV light or elevated temperature’ as conditions for forming a porous metal-oxide film from a coating of a porogenic aqueous precursor. In examples in which elevated temperature is used in lieu of UV exposure, the range of temperatures desirable for a complete cure are consistent with the temperatures induced on the film-coated surface by UV exposure of the wavelength and power ranges disclosed herein. Such temperatures can be determined based on the knowledge of one having ordinary skill in the art to which the disclosure applies. In still other examples, dehydration of the film-coated substrate by extraction of water into an appropriate organic solvent may be used to augment the curing effects of UV exposure and/or elevated temperature, as demonstrated above.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

In conclusion, one aspect of this disclosure is directed to a method for making a porous metal-oxide film via liquid-phase deposition. The method comprises: (a) coating a substrate with a porogenic aqueous precursor comprising one or more metal-ion species, one or more photosensitive agents each selected to interact with at least one of the metal-ion species, and one or more porogen species; and (b) exposing the substrate as coated to one or more of ultraviolet light or elevated temperature under an oxidizing atmosphere, thereby decomposing the one or more photosensitive agents and porogen species and forming a porous network of oxide-bridged metal ions.

In some implementations the at least one of the porogen species comprises a non-ionic, cationic, anionic, or zwitterionic surfactant. In some implementations the one or more photosensitive agents and porogen species photolyze, volatilize, and/or pyrolyze upon exposure to the ultraviolet light or elevated temperature under the oxidizing atmosphere, leaving behind no solid residue other than oxide. In some implementations the method further comprises subjecting the substrate, as coated and exposed, to annealing conditions. In some implementations the film has a refractive index of from 1 to less than 1.55. In some implementations the film is arranged within a series of stacked films of a multi-lamellar film structure. In some implementations each stacked film of the multi-lamellar film structure has a refractive index from 1 to less than 1.55. In some implementations the multi-lamellar film structure supports a discrete refractive-index gradient from a first refractive index to a second refractive index. In some implementations different layers of the multi-lamellar film structure are made using porogenic aqueous precursors of different porogen concentrations, thereby providing different refractive indices for the different layers. In some implementations the method further comprises one or more of: (a) pre-baking the substrate as coated prior to exposure to the ultraviolet light or elevated temperature; or (b) immersing the substrate as coated in a water-miscible solvent after exposure to the ultraviolet light or elevated temperature.

Another aspect of this disclosure is directed to a porogenic aqueous precursor for making a porous metal-oxide film via liquid-phase deposition. The porogenic aqueous precursor comprises: (a) one or more metal-ion species; (b) one or more photosensitive agents each configured to interact with at least one of the metal-ion species; and (c) one or more porogen species.

In some implementations the one or more metal-ion species comprises two or more metal-ion species. In some implementations at least one of the photosensitive agents comprises a Brønsted-Lowry acid. In some implementations at least one of the photosensitive agents is an agent that ionizes in aqueous solution, thereby providing a ligand for at least one of the metal-ion species. In some implementations the one or more photosensitive agents are configured to photolyze, volatilize, and/or pyrolyze upon exposure to ultraviolet light or elevated temperature under an oxidizing atmosphere, leaving behind no solid residue other than oxide. In some implementations the oxidizing atmosphere comprises ozone. In some implementations at least one of the photosensitive agents comprises formic acid. In some implementations at least one of the photosensitive agents comprises hydrogen peroxide. In some implementations at least one of the porogen species comprises a non-ionic, cationic, anionic, or zwitterionic surfactant. In some implementations the one or more porogen species are configured to photolyze, volatilize, and/or pyrolyze upon exposure to ultraviolet light or elevated temperature under an oxidizing atmosphere, leaving behind no solid residue other than oxide.

It will be understood that the configurations and/or approaches described herein are exemplary and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In that spirit, the phrase ‘based at least partly on’ is intended to remind the reader that the functional and/or conditional logic illustrated herein neither requires nor excludes suitable additional logic, executing in combination with the illustrated logic, to provide additional benefits. In some examples the terms ‘about’ and ‘approximately’, as applied to a numeric value x, expand x to include any value in a range between 0.9x and 1.1x; in some examples these terms expand x to include any value in a range between 0.95x and 1.05x.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for making a porous metal-oxide film via liquid-phase deposition, the method comprising:
coating a substrate with a porogenic aqueous precursor comprising one or more metal-ion species, one or more photosensitive agents each selected to interact with at least one of the metal-ion species, and one or more porogen species; and
exposing the substrate as coated to one or more of ultraviolet light or elevated temperature under an oxidizing atmosphere, thereby decomposing the one or more photosensitive agents and porogen species and forming a porous network of oxide-bridged metal ions.

2. The method of claim 1 wherein the at least one of the porogen species comprises a non-ionic, cationic, anionic, or zwitterionic surfactant.

3. The method of claim 1 wherein the one or more photosensitive agents and porogen species photolyze, volatilize, and/or pyrolyze upon exposure to the ultraviolet light or elevated temperature under the oxidizing atmosphere, leaving behind no solid residue other than oxide.

4. The method of claim 1 further comprising subjecting the substrate, as coated and exposed, to annealing conditions.

5. The method of claim 1 wherein the film has a refractive index of from 1 to less than 1.55.

6. The method of claim 1 wherein the film is arranged within a series of stacked films of a multi-lamellar film structure.

7. The method of claim 6 wherein each stacked film of the multi-lamellar film structure has a refractive index from 1 to less than 1.55.

8. The method of claim 6 wherein the multi-lamellar film structure supports a discrete refractive-index gradient from a first refractive index to a second refractive index.

9. The method of claim 7 wherein different layers of the multi-lamellar film structure are made using porogenic aqueous precursors of different porogen concentrations, thereby providing different refractive indices for the different layers.

10. The method of claim 1 further comprising one or more of:
pre-baking the substrate as coated prior to exposure to the ultraviolet light or elevated temperature; or
immersing the substrate as coated in a water-miscible solvent after exposure to the ultraviolet light or elevated temperature.

11. A porogenic aqueous precursor for making a porous metal-oxide film via liquid-phase deposition, the porogenic aqueous precursor comprising:
one or more metal-ion species;
one or more photosensitive agents each configured to interact with at least one of the metal-ion species; and
one or more porogen species.

12. The porogenic aqueous precursor of claim 11 wherein the one or more metal-ion species comprises two or more metal-ion species.

13. The porogenic aqueous precursor of claim 11 wherein at least one of the photosensitive agents comprises a Brønsted-Lowry acid.

14. The porogenic aqueous precursor of claim 11 wherein at least one of the photosensitive agents is an agent that ionizes in aqueous solution, thereby providing a ligand for at least one of the metal-ion species.

15. The porogenic aqueous precursor of claim 11 wherein the one or more photosensitive agents are configured to photolyze, volatilize, and/or pyrolyze upon exposure to ultraviolet light or elevated temperature under an oxidizing atmosphere, leaving behind no solid residue other than oxide.

16. The porogenic aqueous precursor of claim 15 wherein the oxidizing atmosphere comprises ozone.

17. The porogenic aqueous precursor of claim 11 wherein at least one of the photosensitive agents comprises formic acid.

18. The porogenic aqueous precursor of claim 11 wherein at least one of the photosensitive agents comprises hydrogen peroxide.

19. The porogenic aqueous precursor of claim 11 wherein at least one of the porogen species comprises a non-ionic, cationic, anionic, or zwitterionic surfactant.

20. The porogenic aqueous precursor of claim 11 wherein the one or more porogen species are configured to photolyze, volatilize, and/or pyrolyze upon exposure to ultraviolet light or elevated temperature under an oxidizing atmosphere, leaving behind no solid residue other than oxide.
